(19) United States
(12) Patent Application Publication
(10) Pub. No.: US 2008/0030484 A1
(43) Pub. Date: Feb. 7, 2008

(54) DUAL LIQUID CRYSTAL DISPLAY HAVING TOUCH SCREEN

(75) Inventors: Jong-Whan Cho, Gyeonggi-do (KR); Jeong-Geun Yoo, Gyeonggi-do (KR); Yukiya Nishioka, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/835,224

(22) Filed: Aug. 7, 2007

(30) Foreign Application Priority Data
Aug. 7, 2006 (KR) 2006-74077
Aug. 16, 2006 (KR) 2006-76980

(51) Int. Cl. G06F 3/042; G09G 3/36

(52) U.S. Cl. 345/176; 345/87

(57) ABSTRACT

A dual display apparatus includes a display panel and a light unit disposed at a first side of the display panel which includes a light source, a light-guide plate having a first transparent electrode and an optical film having a second transparent electrode opposite to the first transparent electrode. The second transparent electrode produces position information by making electrically contact with the first transparent electrode when the panel is touched.

### CROSS-REFERENCE TO RELATED APPLICATIONS

This application claims priority under 35 U.S.C. §119 to Korean Patent Application No. 2006-74077 filed on Aug. 7, 2006, and Korean Patent Application No. 2006-76980 filed on Aug. 16, 2006, the contents of which are herein incorporated by reference in their entireties.

### BACKGROUND OF THE INVENTION

1. Field of the Invention

The present invention relates to a dual liquid crystal display apparatus and, more particularly, to a dual liquid crystal display apparatus having a touch panel function.

2. Description of the Related Art

Recently, the touch screen panel (TSP) has been applied to various display apparatus including the liquid crystal display (LCD) apparatus.

The TSP detects the position at which a hand or other object makes contact with the screen, provides an input signal indicated by the position touched, and drives the LCD apparatus. Since the LCD apparatus having the TSP does not need separate input devices such as a key pad, use of the LCD apparatus having a TSP is increasing. Where thinness and light weight are important a resistive touch screen may be employed.

When a user compresses a specific position of the touch panel having two opposite conductive layers, the two conductive layers make contact with each other and then the resistive touch panel detects the changes of current or voltage at the contacted position and converts the changes into coordinates. However, when the LCD apparatus includes the touch panel, the total thickness or size of the product increases, properties are decreased and manufacturing costs are increased.

### SUMMARY OF THE INVENTION

The present invention, according to one aspect thereof provides a thinner dual display apparatus having a touch panel function, comprising a display panel and a light unit having a light source, a light-guide plate for guiding the light toward the display panel and having a first transparent electrode and an optical film having a second transparent electrode opposite to the first transparent electrode. The second transparent electrode produces position information by electrically contacting with the first transparent electrode.

The display panel includes a first substrate, a second substrate and a liquid crystal layer. The first substrate has a transmitting pixel that transmits light and a reflecting pixel that reflects light. A first side of the second substrate opposes the first substrate and a second side of the second substrate opposes the light unit. The liquid crystal layer is interposed between the first substrate and the second substrate.

The optical film includes one of transparent polyethylene terephthalate (PET) film and polycarbonate (PC) film. The optical film includes a first polarizer polarizing the light in a first direction.

According to the above, the dual display apparatus displays images in a dual way by using one light unit having one display panel and one touch panel. As a result, the thickness of the dual display apparatus is decreased, optical properties are enhanced and costs are decreased.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view illustrating a dual liquid crystal display (LCD) apparatus in accordance with an exemplary embodiment of the present invention;

FIG. 2 is a cross-sectional view taken along a line I-I′ in FIG. 1;

FIG. 3 is a cross-sectional view for explaining operation of a light unit as a touch panel in FIG. 2;

FIG. 4 is a cross-sectional view illustrating another exemplary embodiment of a light unit in FIG. 2;

FIGS. 5 and 7 side views of a dual LCD apparatus in FIG. 1;

FIG. 6 is a plan view illustrating a portion of a first substrate in FIG. 5;

FIG. 8 is an exploded perspective view illustrating a dual LCD apparatus in accordance with an embodiment of the present invention;

FIG. 9 is a cross-sectional view taken along a line II-II′ in FIG. 8; and

FIG. 10 is a side view of a dual LCD apparatus in FIG. 8.

### DESCRIPTION OF THE EMBODIMENTS

In the drawings, the size and relative sizes of layers and regions may be exaggerated for clarity. It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Exemplary Embodiment of Dual Display Apparatus.

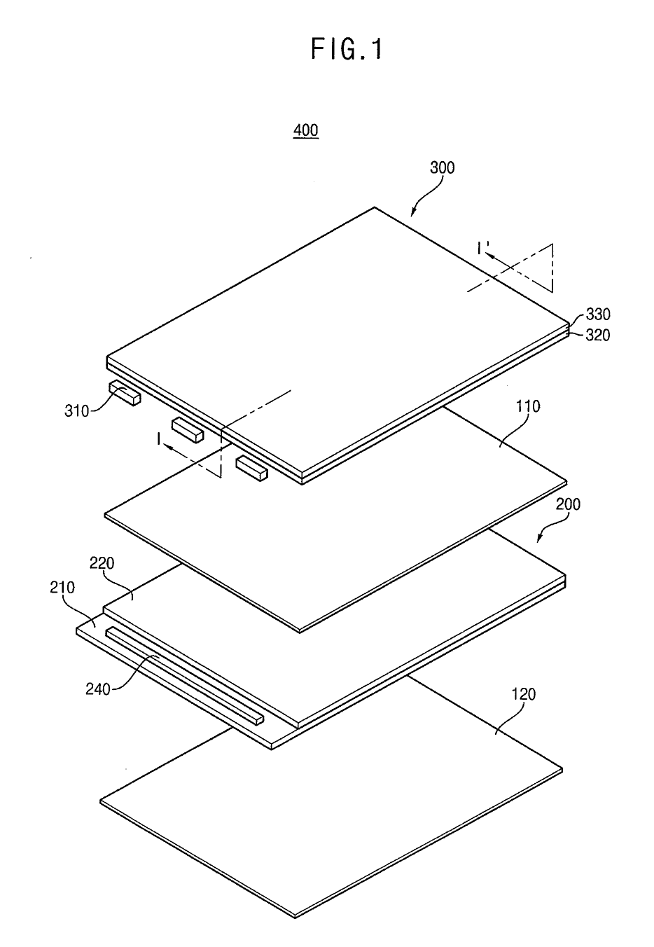

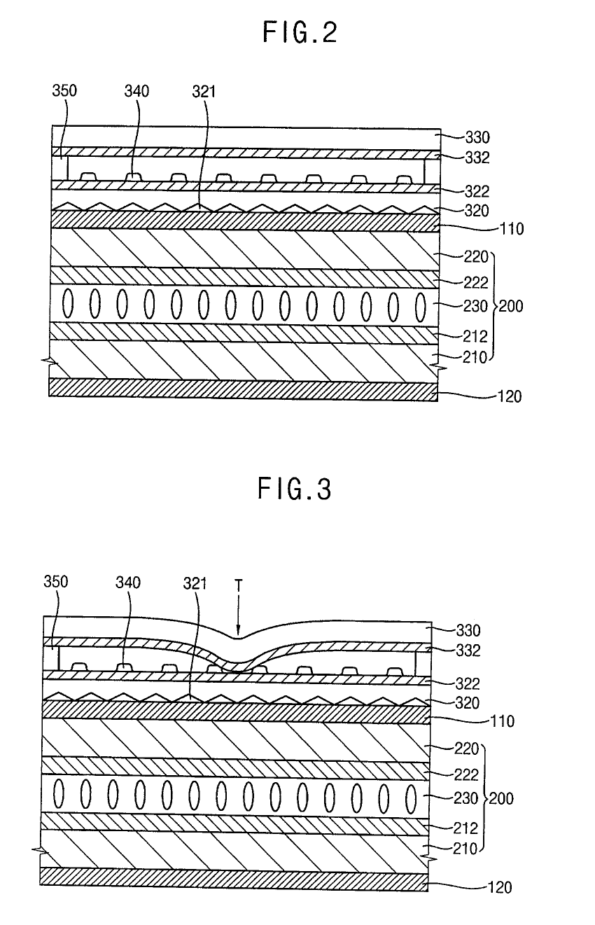

FIG. 1 is an exploded perspective view illustrating a dual LCD apparatus in accordance with an exemplary embodiment of the present invention. FIG. 2 is a cross-sectional view taken along a line I-I′ in FIG. 1. FIG. 3 is a cross-sectional view for explaining operation of a light unit as a touch panel in FIG. 2.

Referring to FIG. 1, a dual display apparatus 400 in accordance with an exemplary embodiment of the present invention includes a display panel 200, a light unit 300, and a first polarizer 110 and a second polarizer 120.

The display panel 200 is disposed under the light unit 300. The display panel 200 displays images in a dual way by using light from the light unit 300. The display panel 200 displays a first image by using light transmitting through the display panel 200. The display panel 200 displays a second image by using light reflected from the display panel 200.

The display panel 200 includes a first substrate 210, a second substrate 220 opposite to the first substrate 210 and a liquid crystal layer 230 interposed between the first and second substrates 210 and 220. The second substrate 220 is adjacent to the light unit 300. A first side of the second substrate 220 may be opposite to the first substrate 210 and a second side of the second substrate 220 may be opposite to the light unit 300.

In an embodiment of the present invention, the first substrate 210 may be a thin-film transistor (TFT) substrate having signal lines, a pixel electrode and a driving device such as a TFT. The second substrate 220 may be a color filter substrate having a common electrode and a color filter for displaying colors.

The liquid crystal layer 230 is disposed between the first and second substrates 210 and 220. When an electric field is generated between the pixel electrode and the common electrode, the arrangement of liquid crystal molecules of the liquid crystal layer 230 is changed thereby changing light transmissivity. As a result, the display panel 200 displays images having the desired contrast.

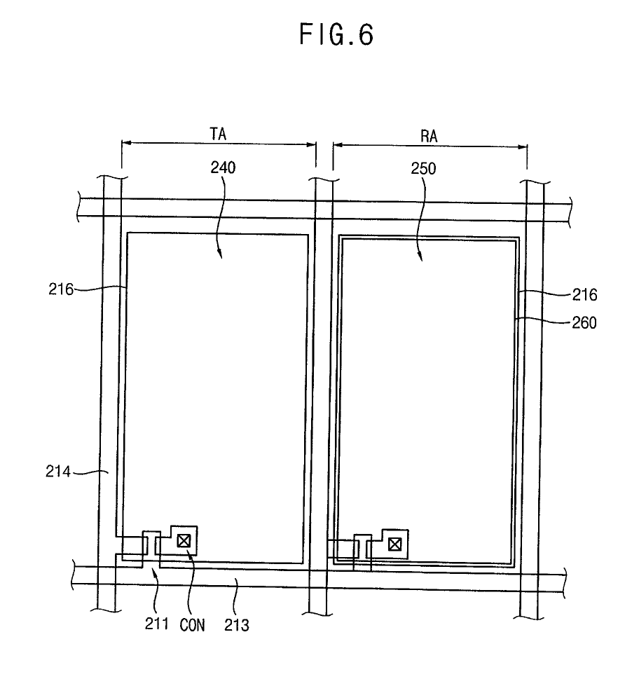

In an embodiment of the present invention, since the first substrate 210 includes a transmitting pixel and a reflecting pixel, the display panel 200 may display images in a dual way. Detailed explanations about a dual display will follow with reference to FIGS. 5 and 6.

The display panel 200 may further include a driving chip 240 for driving the display panel 200. The driving chip 240 generates driving signals for driving the display panel 200 in response to various control signals from an external. For example, the driving chip 240 is included in the first substrate 210 by a chip-on-glass (COG) process.

Referring to FIGS. 1 and 2, the light unit 300 applies light to the display panel 200. The light unit 300 includes a light source 310, a light-guide plate 320, a first transparent electrode 322, an optical film 330, a second transparent electrode 332 and a dot spacer 340.

The light source 310 may be disposed at a lateral side of the light-guide plate 320 and generates light in response to the power from the external. The light source 310 may be a point light source or a fluorescent lamp. For example, the light source 310 includes a light-emitting diode (LED) generating white light. The number of LEDs may be varied as to exiting angle and size of the light-guide plate 320.

The light-guide plate 320 guides light from the light source 310 to exit the light toward the display panel 200. The light-guide plate 320 may include a transparent material for minimizing light loss. For example, the light-guide plate 320 may include polymethyl methacrylate (PMMA) having good hardness.

A light guide plate 320 may have a prism pattern 321. The prism pattern 321 may be formed on the light-guide plate 320. For example, a first face of the light guide plate 320 may include a level face and a second face of the light guide plate 320 may be opposite to the first face at which the prism pattern 321 is formed. The prism pattern 321 concentrates light from the lateral side of the light-guide plate 320 toward the upper portion to enhance the front brightness. For example, the prism pattern 321 may be disposed on or under the light-guide plate 320 and may include a trigonal prism,

The first transparent electrode 322 is disposed on a surface of the light-guide plate 320, which faces the optical film 330. For example, the first transparent electrode 322 includes a transparent conductive material such as indium zinc oxide (IZO) or indium tin oxide (ITO). The first transparent electrode 322 may not be directly formed on the light guide plate 320. For example, the first transparent electrode 322 may be formed on a predetermined film and then the predetermined film having the first transparent electrode 322 may be disposed on the light guide plate 320. That is, the predetermined film where the first transparent electrode 322 is formed may include adhesive film. The predetermined film may be adhered to the light guide plate 320 after forming the first transparent electrode on the predetermined film.

The optical film 330 is disposed on the light-guide plate 320. The optical film 330 is separated from the light-guide plate 320. The optical film 320 may be modified by an external touch. For example, the optical film 320 may include polymer having elasticity. The optical film 320 may include a transparent material to transmit light. For example, the optical film 320 may include polyethylene terephthalate (PET) or polycarbonate (PC).

The second transparent electrode 332 is disposed on a surface of the optical film 330, which faces the light-guide plate 320. For example, the second transparent electrode 332 includes a transparent conductive material like IZO or ITO.

A metal electrode (not shown) may be disposed at the edges of the first and second transparent electrodes 322 and 332 for the first and second transparent electrodes 322 and 332 each to receive different driving voltages from an external power source (not shown).

The dot spacers 340 are disposed between the light-guide plate 320 and the optical film 330. For example, the dot spacers 340 may be formed on the first transparent electrode 322 or the second transparent electrode 332. The dot spacers 340 are separated from each other. For example, the dot spacers 340 are disposed between the first and second transparent electrodes 322 and 332. The dot spacers maintain a gap between the first and second transparent electrodes 322 and 332. For example, the dot spacers 340 may include an insulating resin material such as epoxy or/and acrylic resin. In the embodiment of the present invention, the dot spacers 340 are disposed on the first transparent electrode 322. The dot spacers 340 are disposed under the second transparent electrode 332.

An insulating adhesive 350 is disposed at edges of the first and second transparent electrodes 322 and 332. The light-guide plate 320 and the optical film 330 are connected to each other by the insulating adhesive 350 to form the light unit 300 having a touch panel function. For example, the touch panel function may include a various method such as a resistive method, a surface acoustic wave (SAW) method, a capacitive method, a infrared method, an optical imaging method, a dispersive signal technology, an acoustic pulse recognition method, etc. For example, the insulating adhesive 350 is disposed at edges of the light-guide plate 320 and the optical film 330. The insulating adhesive 350 attaches the light-guide plate 320 and the optical film 330. The light-guide plate 320 and the optical film 330 are apart as thickness of the insulating adhesive 350.

A first polarizer 110 is disposed on the display panel 200. For example, the first polarizer 110 is disposed between the second substrate 220 and the light-guide plate 320. The first polarizer 110 transmits light oscillating along a first direction and absorbs light oscillating along the other direction.

The second polarizer 120 is disposed under a display panel 200. For example, the second polarizer 120 is disposed under the first substrate 210. The second polarizer 120 transmits light oscillating along a second direction and absorbs light oscillating along the other direction. The second polarizer 120 polarizes light transmitting through the liquid crystal layer 230 of the display panel 200.

The direction of the transmitting axis of the first polarizer 110 may be along the first direction and the direction of the transmitting axis of the second polarizer 120 may be along the second direction. For example, the transmitting axis of the first polarizer 110 and the transmitting axis of the second polarizer 120 may make an acute angle or right angle. Alternatively, the transmitting axis of the first polarizer 110 and the transmitting axis of the second polarizer 120 may be substantially parallel with each other.

Referring to FIGS. 2 and 3, when a surface of the optical film 330 is compressed by a pen, a finger, etc., the first and second transparent electrodes 322 and 332 make electrical contact with each other. As a result, a signal having different electrical current or different voltage level is generated at the contact point. A detecting part (not shown) electrically connected to the light unit 300 detects the signal and converts the signal into the coordinates of the contact point.

In order to detect the exact coordinate, the dot spacers 340 may be separated from each other and disposed between the first and second transparent electrodes 322 and 332, so that contact between the first and second transparent electrodes 322 and 332 about the periphery of the actual point pf contact is prevented.

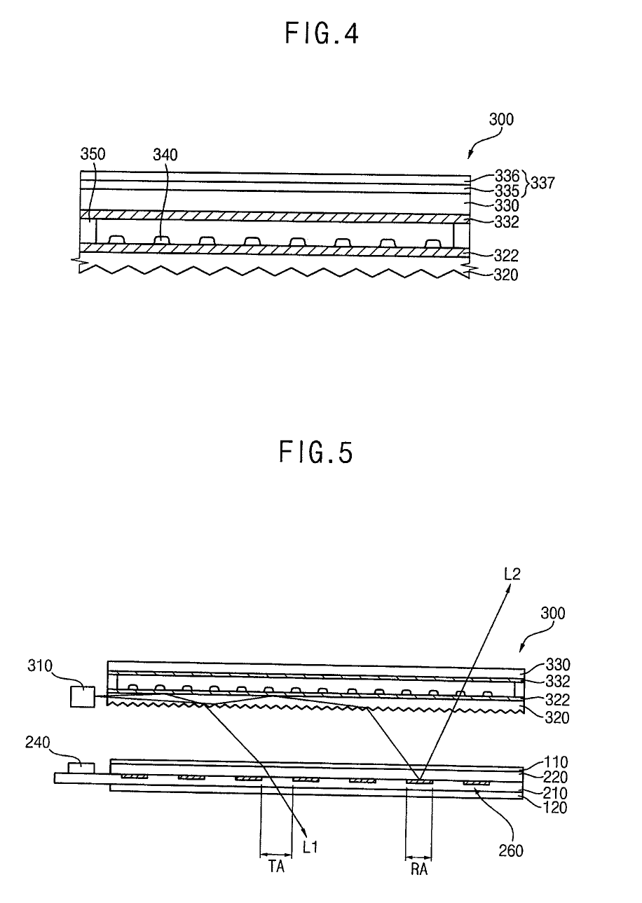

FIG. 4 is a cross-sectional view illustrating another exemplary embodiment of a light unit in FIG. 2.

Referring to FIGS. 3 and 4, the light unit 300 of the embodiment may further comprise a surface treatment film 337 disposed on the optical film 330.

In the dual display, the same portion may be repeatedly compressed by a pen, a finger, etc of a user, so that the surface of the optical film 330 may become abraded. For preventing such damage, a surface treatment film 337 is formed on the optical film 330.

The surface treatment film 337 includes a hard coating layer 335 and a reflection blocking layer 336. The surface treatment film 337 includes a transparent material capable of transmitting light.

The hard coating layer 335 is disposed on the optical film 330 and protects the optical film 330. The surface hardness of the hard coating layer 335 may be high enough to prevent surface scratches. For example, the hard coating layer 335 may include polyacrylic film or acetyl cellulose.

The reflection blocking layer 336 is disposed on the hard coating layer 335. The reflection blocking layer 336 prevents external light from being reflected from the surface of the optical film 330. For example, the reflection blocking layer 336 may include fine particles of acrylic material. Alternatively, the surface of the reflection blocking layer 336 may have a fine convex/conclave shape.

In the embodiment, the surface treatment film 337 includes hard coating layer 335 and reflection blocking layer 336. The surface treatment film 337 may have a double layer of the hard coating layer 335 and the reflection blocking layer 336. The surface treatment film 337 may have a single layer treated for hard coating and anti-reflection for high hardness and reduction of reflection.

FIG. 5 is a side view of a dual LCD apparatus in FIG. 1. FIG. 6 is a plan view illustrating a portion of a first substrate in FIG. 5.

Referring to FIGS. 5 and 6, the display panel 200 displays images by using light exiting from the light unit 300.

The display panel 200 displays a first image by using a first light beam L1. The first light beam L1 is applied from the light unit 300 and transmits the display panel 200. The display panel 200 displays a second image by using a second light beam L2. The second light beam L2 is applied from the light unit 300 and reflected from the display panel 200. For example, the first image and the second image may be substantially the same as each other. Alternatively, the first and second images may be different from each other. For example, the first image may include main images such as image information, letters input by user, received information and/or sending information. The second image may include sub images such as time, date and/or receiving sensitivity.

The display panel 200 includes a first substrate 210 having transmitting pixel 240 and reflecting pixel 250, the second substrate 220 opposite to the first substrate 220 and the liquid crystal layer 230 disposed between the first and second substrates 210 and 220.

First substrate 210 may be an array substrate having a TFT. A plurality of the TFTs is disposed in a matrix configuration. For example, the first substrate 210 includes gate lines 213, data lines 214, TFTs 211 and pixel electrodes. The gate lines 213 and the data lines 214 define the transmitting pixel 240 and the reflecting pixel 250. Each of the TFTs 211 and the pixel electrodes 216 is disposed at the transmitting pixel 240 and the reflecting pixel 250. For example, the transmitting pixel 240 and the reflecting pixel 250 are alternately disposed.

The display panel 200 includes a transmitting area TA having the transmitting pixel 240 and a reflecting area RA having the reflecting pixel 250. For example, a first image is displayed at one side of the display panel 200 by using the first light beam L1 transmitting the transmitting area TA. A second image is displayed at the other side of the display panel 200 by using the second light beam L2 reflected from the reflecting area RA. For example, the first image and the second image may be different from each other.

Alternatively, the transmitting pixel 240 and the reflecting pixel 250 may be disposed at one pixel unit together. The transmitting pixel 240 and the reflecting pixel 250 may receive substantially the same pixel voltage. The first image and the second image may be substantially the same as each other.

TFT 211 applies voltage to the transmitting pixel 240 and the reflecting pixel 250. TFT 211 includes a gate electrode connected to a gate line 213, a source electrode connected to a data line 214 and a drain electrode connected to the pixel electrode 216.

Pixel electrode 216 may include transparent conductive material through which light can be transmitted. For example, the pixel electrode 216 includes IZO or ITO.

Display panel 200 may further include a reflecting layer 260 for reflecting light from the light unit 300. Reflecting layer 260 corresponds to the reflecting pixel 250 to be disposed on the pixel electrode 216 of the first substrate 210. The reflecting layer 260 may include conductive material having good reflectivity for light reflection. For example, the reflecting layer 260 may include aluminum-neodymium (AlNd) material.

The second substrate 220 may include a color filter substrate having a RGB color filter for displaying colors. The RGB color filter may have a thin-film shape. A color filter layer and a common electrode are sequentially formed on the second substrate 220. For example, the common electrode may include a transparent conductive material.

Display panel 200 having the above features displays a first image toward a direction of the first substrate 210 by using a first light beam L1 of the light unit. The first light beam L1 transmits through the transmitting pixel 240. The display panel 200 displays a second image toward a direction of the second substrate 220 by using a second light beam L2. The second light beam L2 is reflected by the reflecting layer 260 disposed at the reflecting pixel 250.

Display panel 200 includes a first substrate 210 and a second substrate 220 opposite to the first substrate 210 and the liquid crystal layer 230 disposed between the first substrate 210 and the second substrate 220. The first substrate 210 may be adjacent to the light unit 300.

According to changes of an arrangement of molecules in the liquid crystal layer 230, light transmissivity is changed. As a result, the display panel 200 displays images having wanted contrast. Thus, in the dual display apparatus having the backlight structure, the reflecting layer 260 may correspond to the reflecting area RA to be disposed under the second substrate 220.

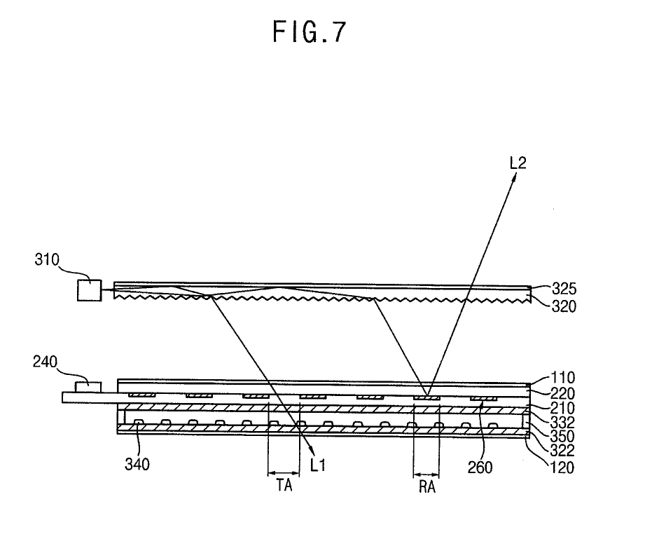

FIG. 7 is a side view of a dual LCD apparatus in FIG. 1. The dual LCD apparatus in illustrated in FIG. 7 is substantially the same as or similar to the dual LCD apparatus in FIG. 5. Thus, the same reference numerals will be used to refer to the same or like parts as those described in FIG. 5 and any further explanation concerning the above elements will be omitted.

Referring to the FIG. 7, a touch panel part including a first transparent electrode 322, the second transparent electrode 332, dot spacers 340 and an insulating adhesive 350 may be formed at a region where a first light beam L1 transmits. A second light beam L2 may transmits through the light guide plate 320 twice or more. The first light beam L1 may transmit through the light guide plate 320 once or less than the second light beam L2. Thus, images by the first light beam L1 may be clearer, more visible and than those by the second light beam L2. In addition images by the first light beam L1 may correspond to the touch panel part better than those by the second light beam L2. When the touch panel part is disposed at a region where the first light beam L1 transmits, errors generated from a difference between a user's touch and images on the display panel may be decreased.

Exemplary Embodiment of Dual Display Apparatus

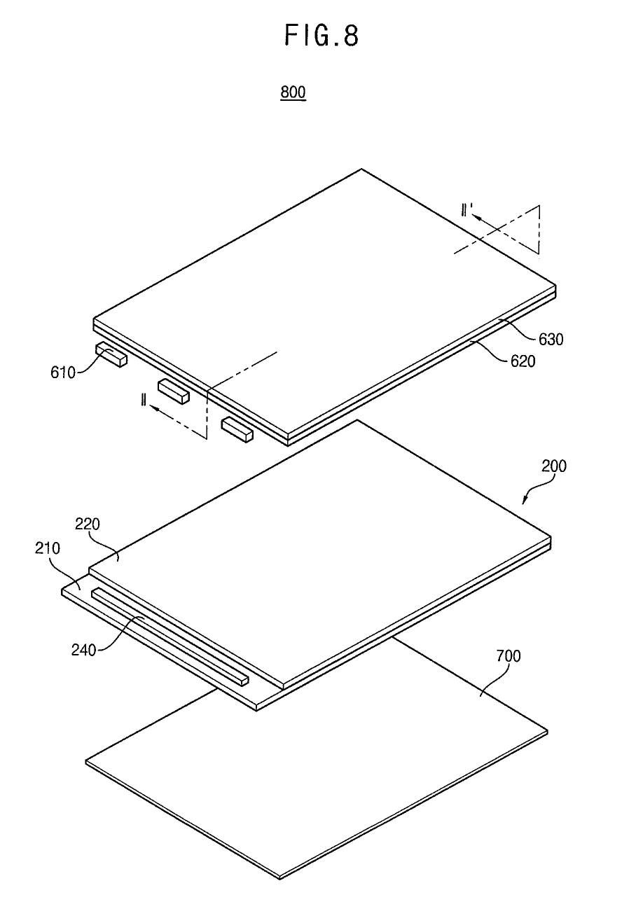

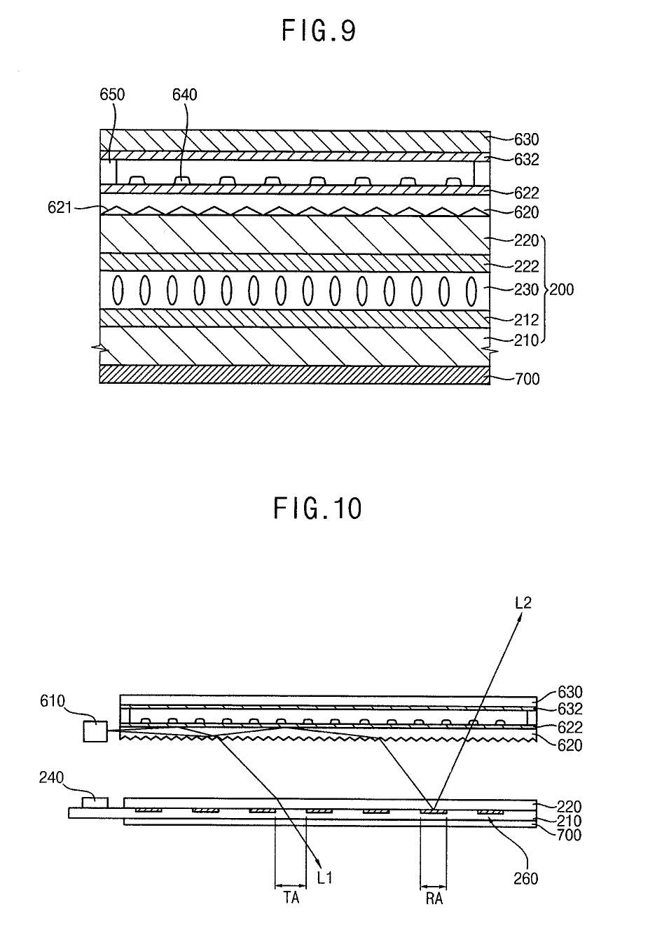

FIG. 8 is an exploded perspective view illustrating a dual LCD apparatus in accordance with an embodiment of the present invention. FIG. 9 is a cross-sectional view taken along a line II-II′ in FIG. 8.

Hereinafter, explanations of elements having substantially the same functions as elements of the dual display apparatus in accordance with the above embodiment will be omitted.

Referring to FIGS. 8 and 9, a dual display apparatus 800 in accordance with an embodiment of the present invention include a display panel 200, a light unit 600 and a second polarizer 700.

The display panel 200 is disposed under the light unit 600. The display panel 200 displays images in a dual way by using light from the light unit 600. The light unit 600 applies light to the display panel 200. The display panel 200 displays a first image by using the light passing through the display panel 200. The display panel 200 displays a second image by using the light reflected from the display panel 200.

The display panel 200 includes a first substrate 210, a second substrate 220 opposite to the first substrate 210 and being adjacent to the light unit 600, a liquid crystal layer 230 disposed between the first and second substrates 210 and 220, and a driving chip 240 for driving the display panel 200. For example, a first side of the second substrate 220 faces the first substrate 210. A second side of the second substrate 220 faces the light unit 600.

The light unit 600 applies light to the display panel 200. The light unit 600 includes a light source 610, a light-guide plate 620, a first transparent electrode 622, a first polarizer 630, a second transparent electrode 632 and dot spacers 640.

The light source 610 is disposed at a side of the light-guide plate 620. The light source 610 generates light in response to power from an external.

The light-guide plate 620 is disposed on the display panel 200. The light-guide plate 620 guides the light from the light source 610 toward the display panel 200.

The first transparent electrode 622 is disposed on a front side of the light-guide plate 620 opposite to the first polarizer 630. For example, the first transparent electrode 622 may include transparent conductive material like ITO or IZO.

The first polarizer 630 is separated from the light-guide plate 620 and disposed over the light-guide plate 620. The first polarizer 630 transmits light oscillating along a first direction and absorbs light oscillating along the other direction. Thus, the first polarizer 630 polarizes light from the light-guide plate 620 which is disposed thereunder.

The first polarizer 630 may be modified by an external touch. For example, the first polarizer 630 may include polymer having elasticity. The first polarizer 630 may include a transparent material for the light to be transmitted. For example, the first polarizer 630 may include polyvinyl alcohol (PVA).

The first polarizer 630 transmits light oscillating along a first direction from outside. The first polarizer 630 absorbs light oscillating along the other direction. Thus, external light entering into the dual display apparatus 800 is not reflected from the first polarizer 630 but is absorbed. Thus, interference between light from the light-guide plate 620 and the external light is minimized to prevent light glare of a user.

For example, a surface treatment film (not shown) having a hard coating layer and a reflection blocking layer may be disposed on the first polarizer 630. The hard coating layer protects the outside of the first polarizer 630. The reflection blocking layer prevents reflection of the external light.

The second transparent electrode 632 is formed on a surface of the first polarizer 630. The first polarizer 630 is opposite to the second transparent electrode 632. For example, the second transparent electrode 632 may include IZO or ITO.

The dot spacers 640 are separated from each other and disposed between the light-guide plate 620 and the first polarizer 630. For example, the dot spacers 640 are disposed between the first transparent electrode 622 and the second transparent electrode 632 and maintain a gap between the first and second transparent electrodes 622 and 632. For example, the dot spacers 640 may be disposed on the first transparent electrode 622 or under the second transparent electrode 632.

An insulating adhesive 650 is disposed at the edge of the first and second transparent electrodes 622 and 632. The light unit 600 may be attached to the insulating adhesive 650. The light unit 600 may have a touch panel function. For example, the first and second transparent electrodes 622 and 632 receive different voltages from an external power source (not shown).

For example, when a surface of the first polarizer is compressed by a touch of a pen or a finger, the first and second transparent electrodes contact each other to be electrically shortened. As a result, a signal having different electrical current or different voltage level is generated in the contact point. A detecting part (not shown) electrically connected to the light unit 300 detects the signal to convert the signal into coordinates and recognizes the chosen contents by the touch.

The second polarizer 700 is disposed under the display panel 200. For example, the second polarizer 700 is disposed under the first substrate 210. The second polarizer 700 transmits light oscillating along a second direction and absorbs light oscillating along the other direction. The second polarizer 700 polarizes light transmitting through the liquid crystal layer 230 of the display panel 200. The second polarizer 700 is adhered to the first substrate 210 by an adhesive or adhesive tape.

For example, the direction of the transmitting axis of the first polarizer 630 may be along the first direction and the direction of the transmitting axis of the second polarizer 700 may be along the second direction. For example, the transmitting axis of the first polarizer 630 and the transmitting axis of the second polarizer 700 may make an acute angle or a right angle. Alternatively, the transmitting axis of the first polarizer 630 and the transmitting axis of the second polarizer 700 may be substantially parallel with each other.

The dual display apparatus 800 of the present exemplary embodiment is substantially the same as the dual display apparatus 400 in the previous exemplary embodiment except for that the first polarizer 630 substitutes for the optical film 300 of the dual display apparatus 400 in FIG. 1. By disposing the first polarizer 630 on the top of the dual display panel 800, it is prevented that external light is reflected from the dual display apparatus 800. As a result, visual of images are enhanced.

FIG. 10 is a side view of a dual LCD apparatus in FIG. 8.

Referring to FIGS. 8 and 10, the display panel 200 displays images by using light from the light unit 600 in a dual way.

The display panel 200 includes the first substrate 210, the second substrate 220 and the liquid crystal layer 230. The first substrate 210 includes the transmitting pixels and the reflecting pixels. The second substrate 220 is opposite to the first substrate 210. The liquid crystal layer 230 is disposed between the first and second substrates 210 and 220. The second substrate 220 is adjacent to the light unit 600. For example, a transmitting area TA and a reflecting area RA are alternately disposed at the first substrate 210.

The display panel 200 displays a first image by using a first light beam L1. The first light beam L1 is applied from the light unit and transmits the display panel 200. The display panel 200 displays a second image by using a second light beam L2. The second light beam L2 is applied from the light unit 600 and reflected from the display panel 200. For example, the first image and the second image are substantially the same as each other. Alternatively, the first image and the second image may be different from each other.

In the present exemplary embodiment, the first polarizer 630 is disposed on the top of the dual display apparatus 800. The second polarizer 700 is disposed at the bottom of the dual display panel. The first and second polarizers 630 and 700 may absorb light entering from an external into the dual display apparatus 800 through an upper portion to prevent the reflection of light from an external. As a result, the dual display apparatus 800 may enhance visibility of the first and second images.

According to the above, by displaying images in a dual way by using light unit and one display panel, thickness of the dual display apparatus can be reduced.

Also, by using one light unit, the number of LEDs as a light source can be reduced. As a result, manufacturing costs can be reduced.

An economical, thin, light and small dual display apparatus can be formed since the light unit has a touch panel function.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a display panel displaying images in a dual way; and
a light unit disposed at a first side of the display panel and applying light to the display panel, the light unit including:
a light source generating light;
a light-guide plate guiding the light toward the display panel and having a first transparent electrode; and
an optical film having a second transparent electrode opposite to the first transparent electrode, the second transparent electrode producing position information by electrically contacting with the first transparent electrode.

2. The display apparatus of claim 1, wherein the display panel comprises:
a first substrate having a transmitting pixel transmitting light and a reflecting pixel reflecting light;
a second substrate having a first side and a second side, the first side of the second substrate being opposite to the first substrate and the second side of the second substrate opposite to the light unit; and
a liquid crystal layer interposed between the first substrate and the second substrate.

3. The display apparatus of claim 2, wherein the reflecting pixel displays a first image through a first side of the display panel by transmitting the light, and the reflecting pixel display a second image through second side of the display panel by reflecting the light.

4. The display apparatus of claim 2 further comprising:
a first polarizer disposed between the second substrate and the light-guide plate, and polarizing the light along a first direction; and
a second polarizer disposed under the first substrate, and polarizing the light along a second direction.

5. The display apparatus of claim 1, wherein the optical film comprises one of transparent polyethylene terephthalate (PET) film and polycarbonate (PC) film.

6. The display apparatus of claim 1, wherein the optical film comprises a first polarizer polarizing the light along the first direction.

7. The display apparatus of claim 6, further comprising a second polarizer disposed at a second side of the display panel, which is opposite to the first side, and polarizes the light along a second direction.

8. The display apparatus of claim 1, wherein the optical film comprises a hard coating layer.

9. The display apparatus of claim 1, wherein the optical film comprises a reflection blocking layer blocking light reflection on the optical film.

10. The display apparatus of claim 1, wherein the light unit further comprises a dot spacer disposed between the first and second transparent electrodes, and maintains a gap between the first and second electrodes.

11. The display apparatus of claim 10, wherein the dot spacer is formed on the first transparent electrode or the second electrode.

12. The display apparatus of claim 1, wherein a prism pattern is formed on a first surface of the light guide plate.

13. The display apparatus of claim 12, wherein the light guide plate includes a second surface opposing to the first surface and including a level face, the first transparent electrode being formed on the second surface.

14. A display apparatus comprising:
a display panel including a transmitting pixel transmitting light and a reflecting pixel reflecting light; and
a light unit disposed below the display panel including:
a light source generating light;
a light-guide plate; and
a sensing unit sensing a touch disposed below the light unit, wherein the light-guide plate guiding the light generating from the light source to the display panel and transmitting an image reflected by the reflecting pixel.

15. The display apparatus of claim 14, wherein the sensing unit comprising:
a film on which a first transparent electrode is formed; and
an optical film having a second electrode opposite to the first transparent electrode, the second transparent electrode producing position information by electrically contacting with the first transparent electrode.

16. The display apparatus of claim 15, wherein the film on which the first transparent film is formed includes an adhesive film.

17. A display apparatus comprising:
a display panel including a light transmitting region and a light reflecting region and displaying images in a dual way;
a light unit including a light source disposed on a first side of the display panel and a light guide plate guiding a light generated from the light source; and
a touch panel part including a first transparent electrode and an optical film having a second electrode opposite to the first transparent electrode, the second transparent electrode producing position information by electrically contacting with the first transparent electrode.
